(19) United States
(12) Patent Application Publication
(10) Pub. No.: US 2018/0008503 A1
(43) Pub. Date: Jan. 11, 2018

(54) Massage Technique and Method(s) of Use

(71) Applicant: Jonathan Wesley Rice, Denver, CO (US)

(72) Inventor: Jonathan Wesley Rice, Denver, CO (US)

(21) Appl. No.: 15/170,210

(22) Filed: Jun. 1, 2016

Related U.S. Application Data
(60) Provisional application No. 62/230,209, filed on Jun. 1, 2015.

(51) Int. Cl. A61H 7/00

(52) U.S. Cl. CPC A61H 7/002; A61H 2203/0456

(57) ABSTRACT

A massage technique is described. Embodiments of the massage technique include implementing a cyclical stroke by a massage therapist on a client. Typically, the method can include, but is not limited to, providing a massage table, having the client lay on the massage table, and then having the massage therapist perform the cyclical stroke repeatedly without breaking contact between the massage therapist and the client.

### CROSS-REFERENCE TO RELATED APPLICATION

This application claims the benefit of U.S. Provisional Application No. 62/230,209, filed Jun. 1, 2015.

### BACKGROUND

Current massage techniques, for instance Swedish massage, require open hand manipulation by a massage therapist that places stress on digits in extension and hyper-extension. As such, massage therapists get fatigue, aches, and pain in their hands from continuous open hand manipulation. This can lead to arthritis and other joint issues in and near the hands. Traditional massage techniques are typically limited to 20-40 strokes per minute that translates into longer massage times placing more strain on the massage therapist.

Therefore, there is a need for a new massage technique that minimizes stress placed on hands and fingers of a massage therapist while at the same time increasing strokes per minute.

### BRIEF DESCRIPTION OF THE DRAWINGS

FIG. 1A is a photograph including several frames illustrating a massage technique according to one embodiment of the present invention.

FIG. 1B is a photograph including several frames illustrating a massage technique according to one embodiment of the present invention.

FIG. 1C is a diagram of a massage technique being implemented according to one embodiment of the present invention.

FIG. 2 is a photograph including several frames illustrating a massage technique according to one embodiment of the present invention.

FIG. 3 is a photograph including several frames illustrating a massage technique according to one embodiment of the present invention.

### DETAILED DESCRIPTION

Embodiments of the present invention include a massage technique and method(s) of use. Typically, the massage technique can allow for a constant contact between a massage therapist and a client. In one instance, the massage technique can implement a substantially cyclical stroke that can incorporate both effleurage and petrissage in a single stroke motion. In one embodiment, the massage technique can include pertissage, effleurage, and lengthening strokes in a singular stroke motion. Pertissage can include pulling, pressing, and kneading. Effleurage can include long and light strokes. The lengthening stroke can include deep gliding strokes with firm pressure to lengthen and broaden a muscle.

In one embodiment, the massage technique can incorporate a stroke that includes, but is not limited to, a substantially 360 degree movement from phalanges in flexion (a first) of the massage therapist to the olecranon (elbow) of the massage therapist, with a substantially 180 degree pivot somewhere during the 360 degree movement. The stroke can provide a never ending sensation, a water flow sensation, a fire flow sensation, and an earth flow sensation. The stroke can be a joint safe orthopedic massage technique. The stroke can provide approximately twice the circulation and lymph movement over the Swedish massage technique. In one instance, the stroke can include a 180 degree internal/external rotation to reset a hand to distal part of a body part being stroked inferior part of limb to keep a continuous motion to restart stroke.

The massage technique described hereinafter can provide benefits to both the massage therapist and to a client. For instance, a massage therapist can prolong a session by implementing the described massage technique. As can be appreciated, and detailed hereafter, the described massage technique does not use flexors and extensors located in the lower arm. Massage therapists with arthritis in their hands can practice the described massage technique with minimal pain. In some instances, a massage therapist may be able to provide more services during a day than previously due to less fatigue. Most of the above mentioned benefits are related to the fact that the described massage technique keeps hands of a massage therapist closed while implementing the massage technique. For instance, there are no open hand manipulations that place stress on the digits of a massage therapist when in extension and hyper-extension, as is currently common.

Benefits for clients include, but are not limited to, continuous contact leading to less abrupt motion, less initial contacts on and off the client, a superior to inferior motion and medial to lateral motion included in a single stroke motion, non-circular manipulation with a particular part of a body of the client, and a centripetal (towards the heart) only movement.

Further benefits of the massage technique include, but are not limited to, approximately 80 strokes per minute, increased coverage of approximately 70% more surface area per stroke, providing increased circulation, providing increased parasympathetic nervous system (PNS) benefit, increased lactic acid release, achieve PNS stimulation faster, more movement to a body of the client, and increased tissue stimulation per session.

In one embodiment, the massage technique can be a parasympathetic stimulating massage. For instance, the massage technique can be a slow, rhythmical, flowing, pain-free, moderate pressure massage that can provide parasympathetic response. The massage technique can provide different agitators for sympathetic nervous system (SNS) and how parasympathetic nervous system (PNS). By creating a PNS response, the massage technique can help provide body rest, digestion, and recovery modes. Activating parasympathetic nervous system responses is an identified method to help with optimal recovery from exercise and from stress in general. The massage technique can be implemented to reduce a dominance of the sympathetic nervous system from physical and mental/emotional stressors and activate the PNS. The massage technique can also be implemented to decrease delayed-onset muscle soreness (DOMS), reduce swelling, and improve athletic performance.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### A Method of Massage Technique

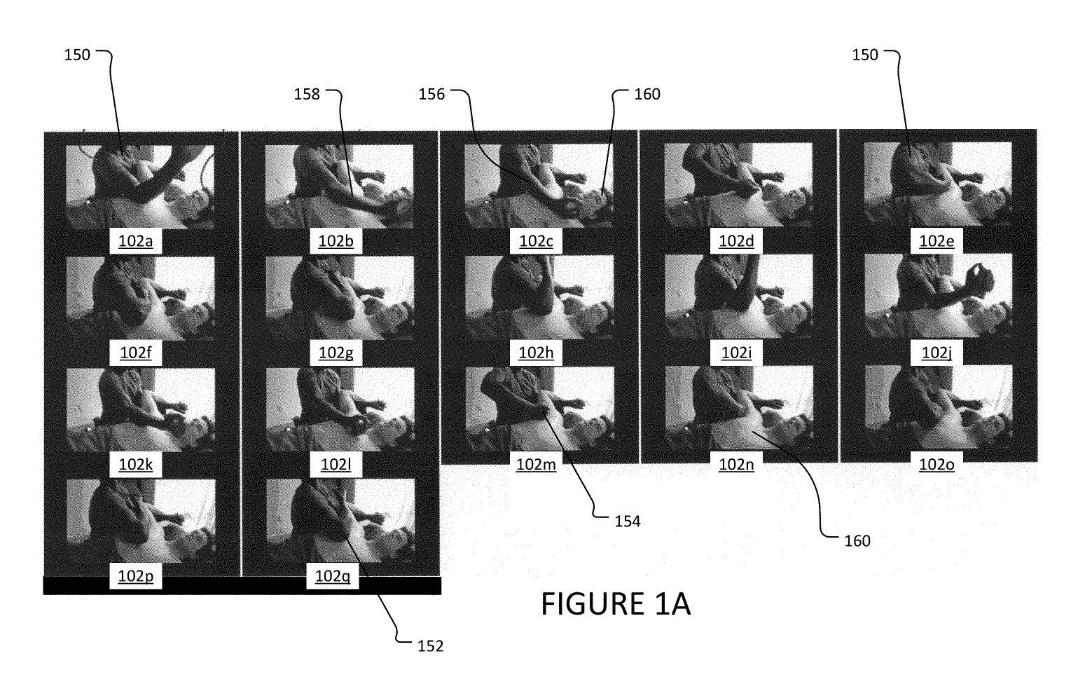

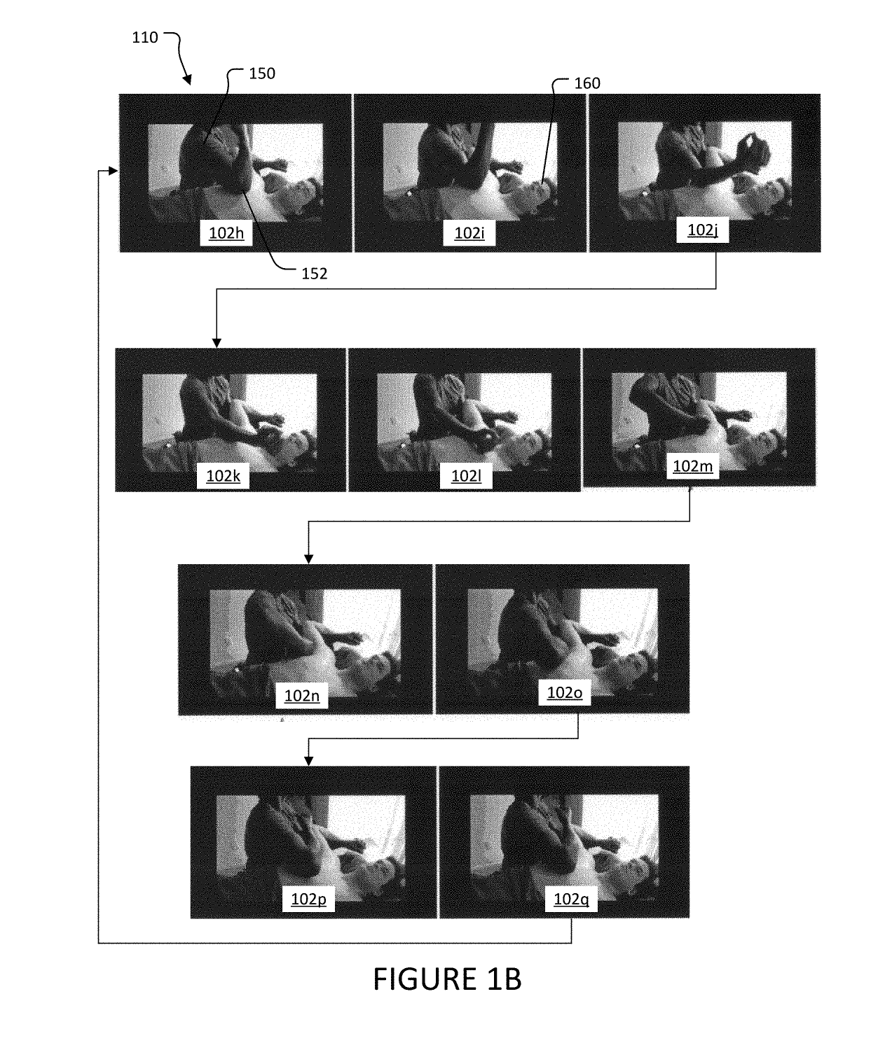

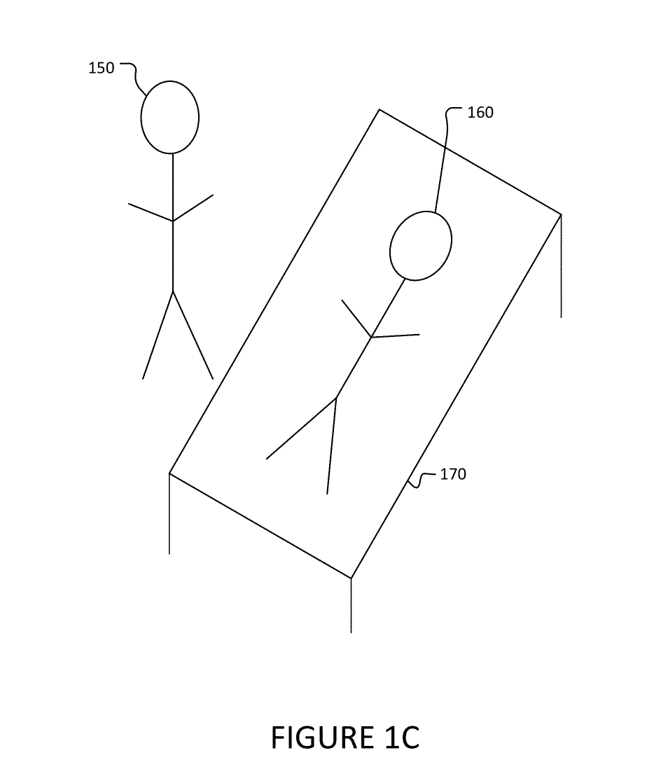

Referring to FIGS. 1A-1B, detailed diagrams of a method (or process) 100 being implemented by a massage therapist 150 is illustrated. The method 100 can include a massage technique that allows for constant contact between the massage therapist 150 and a client (or subject) 160. The massage technique 100 includes the massage therapist 150 using a cyclical stroke 110 to incorporate both effleurage and petrissage in a single stroke movement.

Referring to FIG. 1A, a plurality of frames 102a-102q are illustrated showing each step of the massage technique 100. Referring to the frames 102h-102q, the stroke 110 used to perform the massage technique 100 is illustrated in FIG. 1B. Typically, the stroke 110 can start with either an elbow 152 or a hand 154 of the massage therapist located approximate an area to be massaged. As can be appreciated, the massage therapist can place their hand or elbow at a location on a body of the client to begin the massage technique.

As shown in the frame 102a, the massage therapist 150 can start with their elbow 152 touching the client 160. With the elbow 152 in place, an arm 156 of the massage therapist 150 can be bent at substantially a right angle or at approximately 90 degrees. This will be referred to as a starting position hereinafter. From the starting position, the massage therapist can rotate their forearm 158 down towards the body of the client 160 until the hand 154 and the forearm 158 of the massage therapist 150 can be touching the body of the client 160, as shown generally in the frames 102b and 102c. Generally, the arm of the massage therapist 150 can be substantially straight. Once the forearm 158 and the hand 154 are touching the client 160, the massage therapist 150 can pull their arm back towards their body and rotate their elbow 152 out and away from their body, as shown in the frame 102d. In the frame 102e, the hand 156 is shown in towards the body of the massage therapist 150 and the elbow 152 is extended out from the body. Once the elbow 152 has been rotated away from the body, the massage therapist 150 can pull their hand 154 in towards their body as shown in the frame 102f As the hand 154 is moved towards the body, the hand 154 can be rotated up away from the body of the client 160, as shown in the frame 102g. As shown in the frame 102h, the forearm 158 and the hand 156 can be returned to a vertical position, similar to the starting position shown in the frame 102a. The frames 102i-102q show the massage therapist 150 going back the stroke 110 a second time. As can be appreciated, the massage therapist 150 does not break contact with the client 160 while performing the stroke 110 over and over.

As can be appreciated, the stroke 110 can be one continuous movement from start to finish and can by cyclical. As such, the massage therapist 150 can continuously perform the stroke 110 while keeping contact with the client 160. Generally, the massage therapist can continue the stroke 110 for as long as needed before moving to another location on the body of the client. In some instances, the massage therapist 150 can move their body while performing the stroke 110 to another location and keep contact with the client 160 for an entire session.

Referring to FIG. 1C, a detailed diagram of one embodiment of the massage technique 100 being implemented is illustrated. As shown, the massage technique 100 can include, but is not limited to, providing a massage table 170, having the client 160 lay on the massage table 170, and then having the massage therapist 150 perform the cyclical stroke 110 repeatedly without breaking contact between the massage therapist 150 and the client 160.

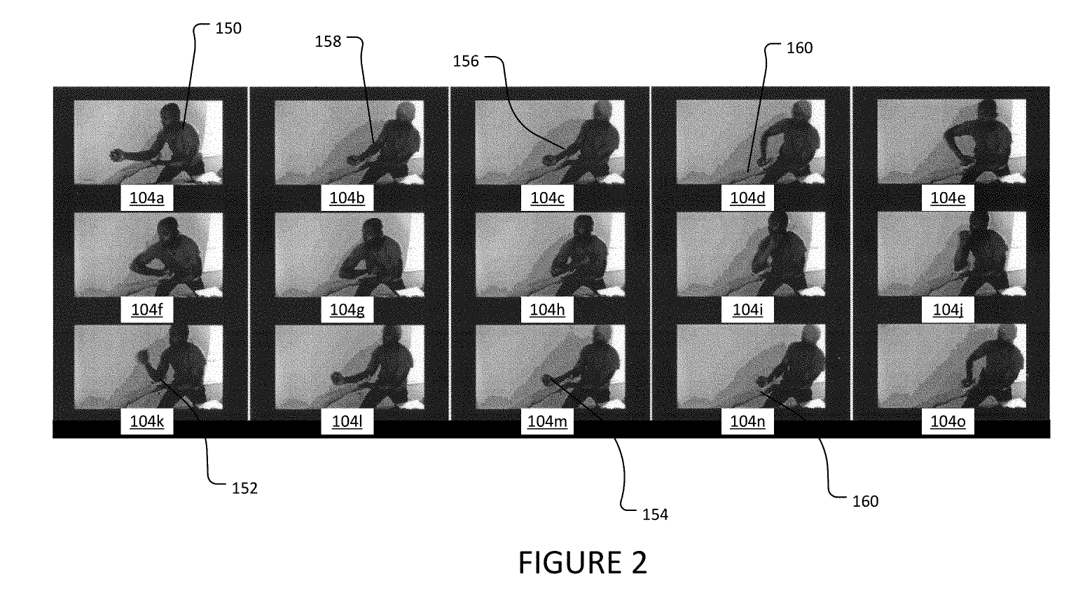

Referring to FIG. 2, a detailed diagram of the massage technique 100 being implemented by the massage therapist 150 on a foot of the client 160, is illustrated. As shown, FIG. 2 includes a plurality of frames 104a-104o showing each step of the massage technique 100. For illustrative purposes only, FIG. 2 includes each step of the massage technique, but from a different starting position and at a different location on the client 160, than shown in FIG. 2.

As shown in the frame 104a, the forearm 156 and the hand 154 of the massage therapist 150 are moving downwards toward the client 160. As the hand 154 and the forearm 158 move downward, the massage therapist 150 can begin to move their entire arm back towards themselves, as shown in the frames 104b-104c. As the arm is moving back, the massage therapist 150 can begin to bend and rotate their arm such that the elbow 152 is moving away from the massage therapist 150, as shown in the frames 104d-104e. Typically, the massage therapist 150 can rotate their arm about a location of the hand 156 approximately 180 degrees as the elbow 152 is pulled back and then away from the massage therapist 150. As shown in the frames 104f-104g, the massage therapist 150 can rotate their elbow 152 down towards the client 160, and then bring their hand 154 back towards the massage therapist 150. Once the elbow 152 gets back to the selected location, the massage therapist 150 can begin to rotate their hand 154 up and away from the client 160, as shown in the frames 104h-104j. The frame 104j can show the massage therapist 150 at the starting position with their elbow 152 located at the selected location to massage. The frames 104k-104o are included to show the massage therapist 150 transitioning from an end of the stroke 110 to a beginning of another one of the strokes 110.

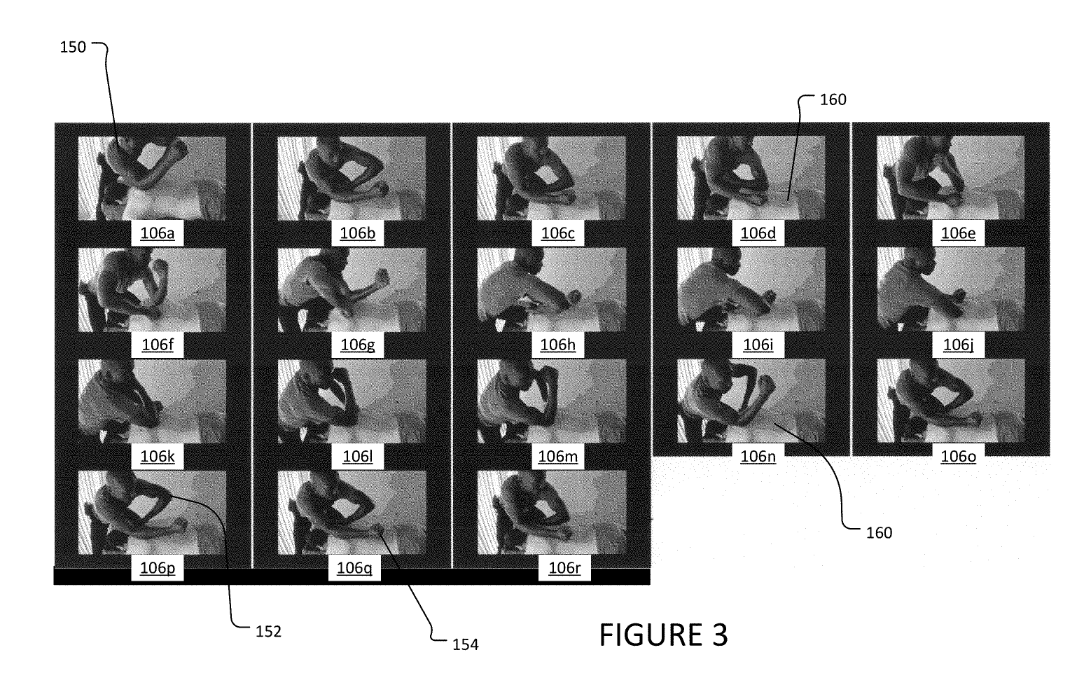

Referring to FIG. 3, a detailed diagram of the massage technique 100 being implemented by both arms of the massage therapist 150 is shown. As shown, the massage therapist 150 can perform the massage technique 100 on the client 160 with two arms to massage different locations simultaneously on the body of the client 150.

As shown, FIG. 3 includes a plurality of frames 106a-106r showing each step of the massage technique 100 being implemented by both arms of the massage therapist 150. The massage therapist 150 can start with one arm having an elbow contacting the client 160 and their other arm having a hand contacting the client 160, as shown in the frame 106a. With the hand and the elbow in place, the massage therapist 150 can begin to perform the stroke 110 with each arm without removing contact with either arm as the stroke 110 is performed, as shown in the frames 106a-106r. Generally, each arm can perform the stroke 110. In some instances, the massage therapist 150 can sync the stroke 110 of each arm to be done in parallel. For example, the massage therapist 150 can start the stroke 110 from the elbow being in contact with the client 160 and the arm at a right angle, or the starting position as previously described. In other instances, and as shown in FIG. 3, the massage therapist 150 can begin with one arm in the starting position and the other arm with the hand contacting the client 160. It is to be appreciated that the massage therapist 150 can use any combination of starting positions with either arm while performing the stroke simultaneously.

### ALTERNATIVE EMBODIMENTS AND VARIATIONS

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A method of performing a massage technique, the method comprising:
providing a massage table;
by a subject, laying down on the massage table;
by a massage therapist, performing a cyclical stroke on the subject, the cyclical stroke comprising:
placing an elbow on the subject proximate an area to be massaged, wherein an arm including the elbow is bent at approximately 90 degrees with a hand located distal to the subject;
rotating the hand down towards the subject until the arm is substantially straight and the elbow, a forearm, and the hand are contacting the subject;
pulling the arm back towards the massage therapist and rotating the elbow up and away from the subject, wherein the arm is bent at approximately 90 degrees with the hand being located proximal to the subject and the elbow being located distal to the subject;
pushing the arm across the massage therapist and rotating the hand up while keeping the arm bent at approximately 90 degrees;
rotating the forearm and the hand approximately 90 degrees.

2. The method of claim 1, wherein the cyclical stroke is continuously repeated.

3. The method of claim 1, wherein the cyclical stroke is performed repeatedly without breaking contact with the subject.

4. The method of claim 1, wherein the massage therapist keeps constant contact with the subject while performing the cyclical stroke.

5. The method of claim 1, wherein the cyclical stroke includes oscillating centripetal strokes.

6. The method of claim 1, wherein the cyclical stroke includes effleurage and petrissage.
